(19) United States
(12) Patent Application Publication
(10) Pub. No.: US 2005/0154981 A1
(43) Pub. Date: Jul. 14, 2005

(54) Document processing method

(76) Inventors: Chung-Ren Wang, Tainan City (TW); Chih-Wei Yang, Rende Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/820,412

(22) Filed: Apr. 8, 2004

(30) Foreign Application Priority Data
Dec. 11, 2003 (TW) 92134996

(51) Int. Cl. G06F 17/00

(52) U.S. Cl. 715/517; 715/513; 715/526; 705/10

(57) ABSTRACT

A document processing method executed in an electronic device. First, three kinds of data are acquired, display capability information and preference information related to a display of a mobile communication device, and a document including a plurality of questions. Next, the style in which the document is displayed on the display of the mobile communication device is determined based on the display capability information, the preference information, and the document.

### BACKGROUND OF THE INVENTION

1. Field of the Invention

The present invention relates to a document processing method, and in particular to a universal document processing method suitable for various displays with different display capabilities and a storage medium using the same.

2. Description of the Related Art

Surveys are a popular tool for market research and others. Surveys usually contain questions about various data the survey designer wishes to know. Conventional surveys are usually presented in the forms of paper or a computer-readable document. With the recent popularity of mobile devices, the conventional survey is being adapted for use thereon.

Surveys are characterized by numerous questions and the dependence of different questions, i.e. the relationship between alternate answers to a certain question and other questions. For example, there may be a survey question to which the first answer “Yes” is related to a fifth question and answer “No” is related to a tenth question. Examinants of the survey thus must skip over questions while searching for the related questions.

Screen specifications of mobile devices vary greatly, hence the survey format must be adjusted for display on various mobile device screens. In the case of a mobile device with a small screen, the survey can be difficult to work with.

Content adaptation techniques have enabled the adjustment of document content on the basis of the document and the browsers installed on various mobile devices, such as image removal or document translation from compact hypertext markup language (CHTML) to wireless markup language (WML). Content adaptation techniques as yet have not addressed the problem of inter-question dependence. When a survey is displayed on different mobile devices, there is still a display style problem in addition to content adjustment.

In another method, a dedicated computer application is designed to process based on display style and inter-question dependence thereof, i.e. the appearance of every survey is customized. This method, however, is time and labor intrusive. Moreover, whenever the inter-question dependence of a survey is altered, the dedicated application must be updated, incurring additional resource expenditure.

Hence, there is a need for a document processing method which can solve the above described problems of display style and inter-question dependence without requiring a dedicated application.

### SUMMARY OF THE INVENTION

Accordingly, an object of the invention is to provide a document processing method capable of solving the above-described problems of display style and inter-question dependence without requiring a dedicated application.

The present invention provides a document processing method executed in an electronic device. First, three kinds of data are acquired, including display capability information and preference information related to a display of a mobile communication device, and a document including a plurality of questions. Next, the display style in which the document is shown on the display of the mobile communication device is determined based on the display capability information, preference information, and the document which include survey questions.

The document processing method may be implemented by a program recorded in a storage medium such as memory or memory device which, when loaded into an electronic device, directs the electronic device to execute the document processing method.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a system including a survey server and a mobile terminal in the preferred embodiment of the invention;

FIG. 2 is a schematic diagram showing an example of the document 5 in the preferred embodiment of the invention;

FIG. 3 is a block diagram of the configuration of the mobile terminal in the preferred embodiment of the invention; and

FIG. 4 is a flowchart of the document processing method according to the preferred embodiment of the invention.

### DETAILED DESCRIPTION OF THE INVENTION

The present invention provides a document processing method which can solve the problems of display style and inter-question dependence without requiring a dedicated application.

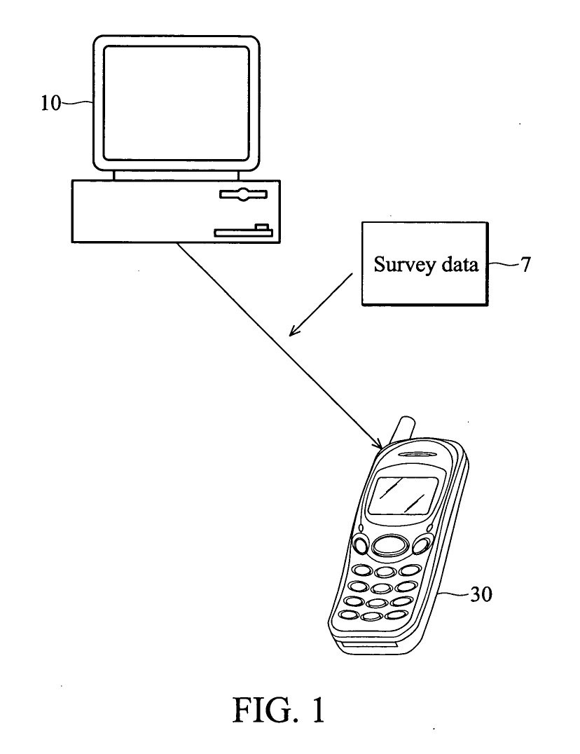

FIG. 1 is a schematic diagram of a system including a survey server and a mobile terminal. The survey server 10 transmits survey data 7 to the mobile terminal 30. The mobile terminal 30 may be a personal digital assistant (PDA) or a smart phone. The survey data 7 includes two components, document 5 and document processing model 6.

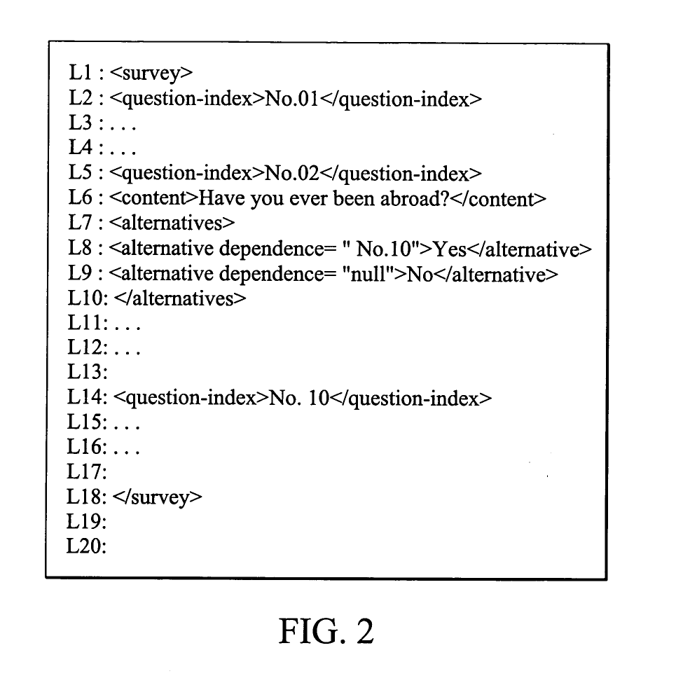

FIG. 2 is a schematic diagram showing an example of the document 5. In the present embodiment, the document 5 is a document based on the extensible markup language (XML). The document 5 contains a plurality of questions each corresponds to a question index labeled with an identification tag as shown on line L2, L5 and L14. In addition, an inter-question dependence is recorded in the document 5, such as those labeled between dependence tags on line L8 and L9.

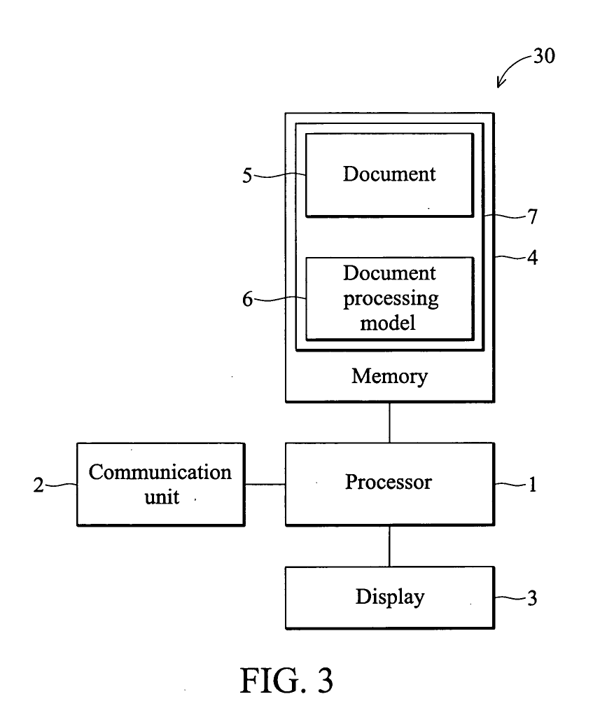

FIG. 3 shows a block diagram of the configuration of the mobile terminal in the preferred embodiment of the invention. The mobile terminal 30 includes a processor 1, communication unit 2, display 3 and memory 4. The processor 1 is coupled with the communication unit 2, display 3 and memory 4.

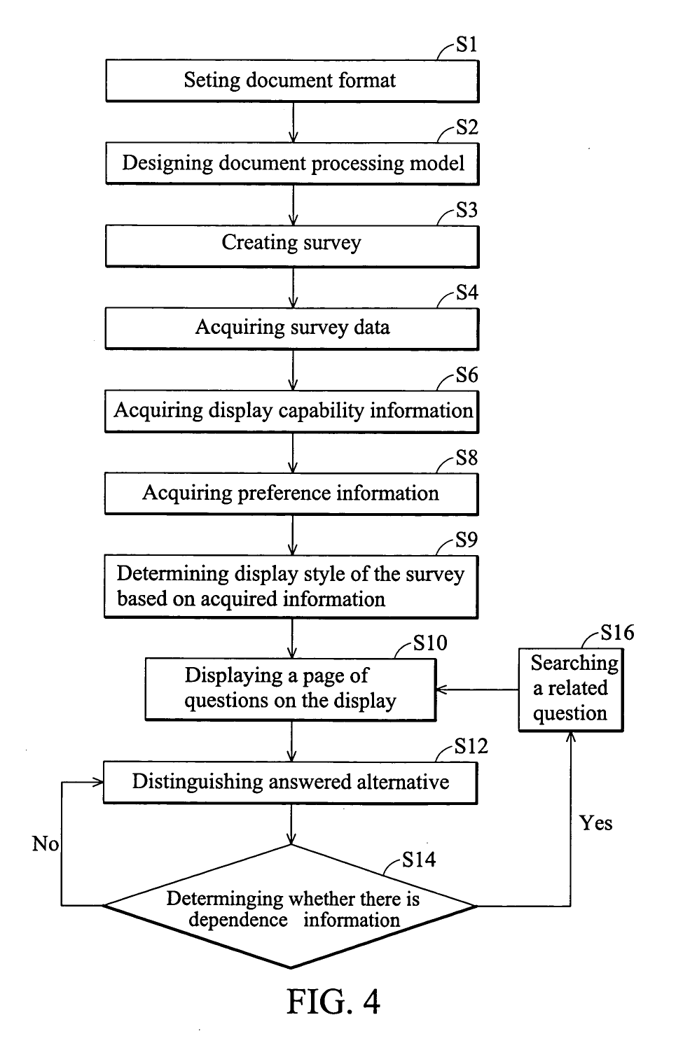

FIG. 4 is a flowchart of the document processing method according to the preferred embodiment of the invention. The survey data design process is shown in steps S1-S3. First, the designer of the survey data determines the program analyzable document format used to describe question indexes, question content and inter-question dependence (step S1). In the preferred embodiment, the document format uses XML tags.

Next, a document processing model 6 is designed (step S2). The document processing model is a computer program containing instructions for implementing the document processing method of the invention. The document processing model 6 may be recorded in a memory or a memory apparatus and, when loaded into a computing device, can direct the computing device to execute the document processing method.

Additionally, the document 5 is designed conforming to the document format (step S3). The document 5 is marked with a plurality of tags to record question indexes, question content and inter-question dependence, as shown in FIG. 2. The document 5 and the document processing model 6 are stored in survey server 10.

After survey server 10 has transmitted the survey data 7 to communication terminal 30, the processor 1 receives the survey data via the communication unit 2 and then stores it in the memory 4 (step S4). The processor 1 performs the following steps according to the document processing model 6. In the preferred embodiment, the processor 1 acquires information about size and resolution of display 3 as display capability information using the techniques of composite capability/preferences profiles (CC/PP) (step S6). CC/PP is a framework based on the resource description framework (RDF). The processor 1 additionally acquires preference information of the communication terminal 30, such as character format comprising font sizes, font types, or font colors (step S8).

The processor 1 determines the display style of the document 5 based on the display capability information, the preference information and properties of document 5, such as number of questions or character number per question (step S9). The processor 1 composes and then displays a page of questions via display 3 using the extensible stylesheet language (XSL) (step S10).

The processor 1 distinguishes an alternative of a question answered by the user of the communication terminal 30 as an examinant (step S12). The processor 1 determines whether there is dependence information related to the answered alternative, which records the dependence of the alternative and another question (step S14). If there is no dependence information related to the answered alternative, the processor 1 distinguishes an alternative of the next question. If there is dependence information related to the answered alternative, the processor 1 searches for the question related to the answer alternative (step S16), and then displays the related question on display 3 (step 10).

For example, when the user chooses an alternative “Yes” to answer question No. 2, the processor 1 distinguishes the alternative. When determining the alternative has dependence information, the processor 1 locates the dependence information showing the alternative “Yes” as related to question No. 10, as shown on line L8 of FIG. 2. Thus, the processor 1 locates the question No. 10 on line L14. The processor 1 then displays the located related question on display 3.

The advantage of the arrangement where inter-question dependence information is recorded in document 5 is that the application of document processing model 6 need not to be updated when a new survey is generated or the inter-question dependence of document 5 changes. When the inter-question dependence of document 5 is changed, only document 5 requires amendment, rather than the application, hence costs are reduced. Moreover, the arrangement wherein the processor 1 determines the display style of document 5 according to the document properties, display capability and preference information of the terminal eliminates the need for customized document processing models for various mobile terminals with different display capability, thus reducing time and labor expenditures.

In the preferred embodiment of the invention, the common document processing method is executed on a mobile communication terminal, rather than on a survey server. The objective of the invention can also be achieved when the document processing method is executed on a survey server. First, the survey server comprising a document acquires size and resolution information of a display of a mobile communication terminal as display capability information and preferences thereof as preference information. Next, the survey server determines, based on the property of the document, the display capability information and the preference information, the display style of the document, composes one page of questions of the document and transmits the page to the mobile communication terminal. The mobile communication terminal displays the page on the display.

In the preferred embodiment of the invention, the display capability information indicates the display capability of display 3 of mobile communication terminal 30, and may further include display capability information of an application executed on the terminal, for identifying and revealing the document 5.

In the preferred embodiment of the invention, although a survey is illustrated to describe the document processing method, the document processing method of the invention can be applied to other documents, such as resumes or others.

The document processing method of the invention can be implemented with a computer program stored in a storage medium such as memory or memory apparatus. When loaded into a computing device, the computer program can direct the computing device to execute the document processing method.

Therefore, the document processing method of the invention can solve the problems of display style and inter-question dependence without requiring a dedicated application.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A document processing method, comprising the steps of:
acquiring display capability information and preference information of a display of a mobile communication device, and a document including a plurality of questions; and
determining the style in which the document is displayed on the display of the mobile communication device based on the display capability information, the preference information, and features of the document.

2. The method as claimed in claim 1, wherein the document contains inter-question dependence information, analyzable by a program.

3. The method as claimed in claim 2, wherein the document conforms to the extensible markup language (XML).

4. The method as claimed in claim 2, wherein the questions correspond to question indexes, and the dependence information contains the correspondence of a question index of a question and an alternative of another question, further comprising the steps of:
distinguishing the alternative; and
displaying the question corresponding to the alternative based on the alternative and the dependence information.

5. The method as claimed in claim 2, further comprising the step of:
displaying the document using the extensible stylesheet language (XSL).

6. The method as claimed in claim 1, wherein the preference information is acquired using techniques of composite capability/preference profile in the acquiring step.

7. The method as claimed in claim 1, wherein the display capability information includes at least one of display capability information of the display or application for displaying the document, and the display capability information of the display includes at least size or resolution information of the display.

8. The method as claimed in claim 1, wherein the preference information includes at least one of font size, font type or font color.

9. The method as claimed in claim 1, wherein the features of the document includes at least the total number of questions and character numbers of a question.

10. A machine-readable storage medium storing a computer program which, when executed, directs a computer to perform a document processing method, comprising the steps of:
receiving display capability information and preference information related to a display of a mobile communication device, and a document including a plurality of questions; and
determining the display style in which the document is shown on the display of the mobile communication device based on the display capability information, the preference information, and features of the document.

11. The storage medium as claimed in claim 10, wherein the document contains dependence information of the questions, which is analyzable by the computer program.

12. The storage medium as claimed in claim 11, wherein the document conforms to the extensible markup language (XML).

13. The storage medium as claimed in claim 11, wherein each of the questions correspond to a question index, and the dependence information contains the correspondence of a question index of a question and an alternative of another question, and the document processing method further comprises the steps of:
distinguishing the alternative; and
displaying the question corresponding to the alternative based on the alternative and the dependence information.

14. The storage medium as claimed in claim 11, wherein the document processing method further comprises the step of:
displaying the document using extensible the stylesheet language (XSL).

15. The storage medium as claimed in claim 10, wherein the preference information is received using techniques of composite capability/preference profile in the receiving step.

16. The storage medium as claimed in claim 10, wherein the display capability information includes at least display capability information of the display or application for displaying the document, and the display capability information of the display includes at least size or resolution information of the display.

17. The storage medium as claimed in claim 10, wherein the preference information includes at least one of font size, font type, or font color.

18. The storage medium as claimed in claim 10, wherein the features of the document includes at least the total number of questions and character number of a question.
